(19) United States
(12) Patent Application Publication
(10) Pub. No.: US 2026/0313635 A1
(43) Pub. Date: Oct. 8, 2026

(54) MODULATION AND CODING SCHEME FOR SINGLE TRANSPORT BLOCK TRANSMISSION

(71) Applicant: Lenovo (United States) Inc., Morrisville, NC (US)

(72) Inventors: Joachim Löhr, Wiesbaden (DE); Alexander Golitschek Edler von Elbwart, Darmstadt (DE)

(73) Assignee: Lenovo (United States) Inc., Morrisville, NC (US)

(21) Appl. No.: 19/170,926

(22) Filed: Apr. 4, 2025

(51) Int. Cl. H04W 72/1263; H04L 1/1812

(52) U.S. Cl. CPC H04W 72/1263; H04L 1/1812

(57) ABSTRACT

Various aspects of the present disclosure relate to modulation and coding scheme (MCS) for single transport block (TB) transmission. A user equipment (UE) may receive downlink control information (DCI) that includes an uplink resource assignment for a scheduled uplink transmission, and the DCI includes an indication of at least one modulation and coding scheme (MCS) for the scheduled uplink transmission. The UE may allocate uplink resources for the scheduled uplink transmission from a set of logical channels (LCHs), where a quantity of the uplink resources that are allocated for an LCH of the set of LCHs is based on one or more parameters associated with the LCH, and the one or more parameters include the at least one MCS for the scheduled uplink transmission.

### TECHNICAL FIELD

The present disclosure relates to wireless communications, and more specifically to modulation and coding scheme (MCS) for data transmission.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

A UE for wireless communication is described. The UE may be configured to, capable of, or operable to perform one or more operations as described herein. For example, the UE may be configured to, capable of, or operable to receive downlink control information (DCI) that includes an uplink resource assignment for a scheduled uplink transmission, and the DCI includes an indication of at least one MCS for the scheduled uplink transmission; and allocate uplink resources for the scheduled uplink transmission from a set of logical channels (LCHs), where a quantity of the uplink resources that are allocated for an LCH of the set of LCHs is based on one or more parameters associated with the LCH, and the one or more parameters include the at least one MCS for the scheduled uplink transmission.

A processor (e.g., a standalone processor chipset, or a component of a UE) for wireless communication is described. The processor may be configured to, capable of, or operable to perform one or more operations as described herein. For example, the processor may be configured to, capable of, or operable to receive DCI that includes an uplink resource assignment for a scheduled uplink transmission, and the DCI includes an indication of at least one MCS for the scheduled uplink transmission; and allocate uplink resources for the scheduled uplink transmission from a set of LCHs, where a quantity of the uplink resources that are allocated for an LCH of the set of LCHs is based on one or more parameters associated with the LCH, and the one or more parameters include the at least one MCS for the scheduled uplink transmission.

A method performed or performable by a UE for wireless communication is described. The method may include receiving DCI that includes an uplink resource assignment for a scheduled uplink transmission, and the DCI includes an indication of at least one MCS for the scheduled uplink transmission; and allocating uplink resources for the scheduled uplink transmission from a set of LCHs, where a quantity of the uplink resources that are allocated for an LCH of the set of LCHs is based on one or more parameters associated with the LCH, and the one or more parameters include the at least one MCS for the scheduled uplink transmission.

In some implementations of the UE, the processor, and the method described herein, the DCI is an uplink DCI that allocates physical uplink shared channel (PUSCH) resources for an initial hybrid automatic repeat request (HARQ) transmission. In some implementations of the UE, the processor, and the method described herein, the one or more parameters includes at least a priority and a prioritized bit rate configured for the LCH.

In some implementations of the UE, the processor, and the method described herein, the UE, the processor, and the method may be configured to, capable of, or operable to apply one MCS to the LCH for the scheduled uplink transmission based on at least one of the indication of the at least one MCS received in the DCI, or quality of service (QoS) requirements of the LCH. In some implementations of the UE, the processor, and the method described herein, the UE, the processor, and the method may be configured to, capable of, or operable to apply one MCS to the LCH for the scheduled uplink transmission based at least in part on a network configuration.

In some implementations of the UE, the processor, and the method described herein, the network configuration indicates to apply a lower or higher MCS relative to a reference MCS for the LCH. In some implementations of the UE, the processor, and the method described herein, the at least one MCS is a reference MCS. In some implementations of the UE, the processor, and the method described herein, the DCI includes the indication of the at least one MCS that is applied for highest priority data in a transport block (TB). In some implementations of the UE, the processor, and the method described herein, medium access control-control elements (MAC CEs) in a TB utilize a lowest MCS for at least one of code blocks (CBs) or code block groups (CBGs) of the TB.

In some implementations of the UE, the processor, and the method described herein, the TB includes multiple CBGs, and a CBG of the multiple CBGs is associated with one MCS. In some implementations of the UE, the processor, and the method described herein, at least one of a size of at least one CB of the CBs in the TB is a different size than another CB of the CBs; or a size of at least one CBG of the CBGs in the TB is a different size than another CBG of the CBGs. In some implementations of the UE, the processor, and the method described herein, coded bits of a CBG are received based on the MCS applied to a corresponding RB range.

In some implementations of the UE, the processor, and the method described herein, the UE, the processor, and the method may be configured to, capable of, or operable to determine a transport block size (TBS) from a set of partial TBSs, wherein a partial TBS is determined based on the at least one MCS applicable to a RB range and a number of scheduled RBs in the RB range. In some implementations of the UE, the processor, and the method described herein, the TBS is determined based on a summation of the set of partial TBSs.

An NE (e.g., a base station) for wireless communication is described. The NE may be configured to, capable of, or operable to perform one or more operations as described herein. For example, the NE may be configured to, capable of, or operable to transmit DCI that includes an uplink resource assignment for a scheduled uplink transmission, and the DCI includes an indication of at least one MCS for the scheduled uplink transmission, wherein the DCI is usable to allocate uplink resources for the scheduled uplink transmission from a set of LCHs, where a quantity of the uplink resources that are allocated for an LCH of the set of LCHs is based on one or more parameters associated with the LCH, and the one or more parameters include the at least one MCS for the scheduled uplink transmission.

A processor (e.g., a standalone processor chipset, or a component of a NE) for wireless communication is described. The processor may be configured to, capable of, or operable to perform one or more operations as described herein. For example, the processor may be configured to, capable of, or operable to transmit DCI that includes an uplink resource assignment for a scheduled uplink transmission, and the DCI includes an indication of at least one MCS for the scheduled uplink transmission, wherein the DCI is usable to allocate uplink resources for the scheduled uplink transmission from a set of LCHs, where a quantity of the uplink resources that are allocated for an LCH of the set of LCHs is based on one or more parameters associated with the LCH, and the one or more parameters include the at least one MCS for the scheduled uplink transmission.

A method performed or performable by an NE (e.g., a base station) for wireless communication is described. The method may include transmitting DCI that includes an uplink resource assignment for a scheduled uplink transmission, and the DCI includes an indication of at least one MCS for the scheduled uplink transmission, where the DCI is usable to allocate uplink resources for the scheduled uplink transmission from a set of LCHs, where a quantity of the uplink resources that are allocated for an LCH of the set of LCHs is based on one or more parameters associated with the LCH, and the one or more parameters include the at least one MCS for the scheduled uplink transmission.

In some implementations of the NE, the processor, and the method described herein, the DCI is an uplink DCI that allocates PUSCH resources for an initial HARQ transmission. The one or more parameters includes at least a priority and a prioritized bit rate configured for the LCH. In some implementations of the NE, the processor, and the method described herein, the network configuration indicates to apply a lower or higher MCS relative to a reference MCS for the LCH. The at least one MCS is a reference MCS. The DCI includes the indication of the at least one MCS that is applied for highest priority data in a TB.

### BRIEF DESCRIPTION OF THE DRAWINGS

FIG. 1 illustrates an example of a wireless communications system in accordance with aspects of the present disclosure.

FIG. 2 illustrates an example of wireless communication in accordance with aspects of the present disclosure.

FIG. 3 illustrates an example of channel fluctuation, in accordance with aspects of the present disclosure.

FIG. 4 illustrates an example of a transport block, in accordance with aspects of the present disclosure.

FIG. 5 illustrates a flowchart of an example UE procedure, in accordance with aspects of the present disclosure.

FIG. 6 illustrates an example of a UE in accordance with aspects of the present disclosure.

FIG. 7 illustrates an example of a processor in accordance with aspects of the present disclosure.

FIG. 8 illustrates an example of an NE in accordance with aspects of the present disclosure.

FIG. 9 illustrates a flowchart of a method performed by a UE in accordance with aspects of the present disclosure.

FIG. 10 illustrates a flowchart of a method performed by an NE in accordance with aspects of the present disclosure.

### DETAILED DESCRIPTION

In a wireless communications system, a TB refers to a block of data (e.g., a data payload) communicated (e.g., transmitted, sent, output, received, signaled) between a physical layer and one or more higher layers (e.g., medium access control (MAC) layer). At a transmitter side, the MAC layer organizes data to be communicated into TBs, and the physical layer processes (e.g., encodes, modulates) the TBs for communication. At a receiver side, the physical layer processes (e.g., decodes, demodulates) the communication (e.g., reception, received) signal to extract the TBs, and provides the TBs to the MAC layer. The TB can be divided into multiple smaller blocks referred to as data blocks, CBs, or CBGs, allowing larger amounts of data to be encoded, transmitted, and decoded efficiently. Different data blocks, CBs, and/or CBGs can be grouped into or associated with different LCHs, where each LCH can carry different types of data (e.g., control data, user data, signaling data, and so forth). Each LCH can be associated with a different priority, such as higher priority LCHs having higher quality of service (QoS) requirements or settings than lower priority LCHs.

A data block is communicated (e.g., transmitted, sent, signaled) on one or more resource blocks (RBs). An RB refers to a unit of time and frequency resources. For example, for 5G NR, an RB may include twelve (12) subcarriers in the frequency domain and a number of orthogonal frequency division multiplexing (OFDM) symbols in the time domain (e.g., depending on the subcarrier spacing).

Some wireless communications systems, such as 6G systems, may support a bandwidth in a wider range than previous wireless communications systems, such as a bandwidth in the range of approximately 100 megahertz (MHz) or more. In such situations, the radio channel (e.g., depending on the environment and/or deployment) may encounter not only small-scale fluctuations within a few decibels (dB), but may also encounter larger fluctuations. This may be compensated for in link adaptation by selecting an MCS that is adapted to the average link quality over the assigned bandwidth. The resource signaling for 5G NR supports only a single MCS signaling per TB for a downlink resource assignment or an uplink resource grant.

Given the single MCS signaling per TB, current (5G NR) link adaptation cannot exploit frequency ranges with better signal-to-interference-plus-noise ratio (SINR) by a reduced forward error correction (FEC) overhead, nor can it assign a more robust FEC to data mapped on frequency ranges with a poor MCS. This becomes particularly relevant for a case of very narrow beams, where there is no or extremely limited flexibility to assign frequency ranges according to the best channel out of a group of UEs (such as RB range 1 to UE1 with good SINR, RB range 2 to UE2 with good SINR). Currently, only a single TB transmission using one MCS is supported in the UE. Accordingly, the current techniques do not support multiple concurrent TBs or PUSCHs in a slot (5G NR). Another drawback of the current link adaptation and resource signaling scheme (up to 5G NR) is that the transport block generation and transmission procedure is inefficient, with only a single common MCS applied to all of the data multiplexed in a TB, even though the data of different LCHs may have different QoS requirements. Typically, the MCS for a TB is selected by the network for the highest demanding QoS of the data in a TB. However, this approach cannot exploit transmission of data parts in a TB with a reduced FEC overhead or higher MCS in general.

Aspects of the present disclosure are described in the context of a wireless communications system. As described herein, the techniques support a transport block being comprised of CB and/or CBG(s) using a different MCS. A new LCH prioritization procedure is described that considers the QoS requirements of LCHs when generating a TB and determining an MCS to use for the corresponding CB and/or CBG the data is transmitted in. The techniques support CB(s) and/or CBG(s) of flexible length. In addition, a new power control mechanism supports multiple MCS in a PUSCH transmission, as described herein.

Aspects of this disclosure are related to a transport block or MAC PDU that includes data of one or more LCHs, where the data of different LCHs may have a different code rate and/or modulation order. The size of the CBs and/or CBGs of a MAC PDU or TB may differ (e.g., the CBs and/or CBGs of a TB may have different sizes). The MCS (code rate) per CB or CBG is flexible, where the MCS of a CB or CBG is selected depending on the QoS requirements of the data.

Aspects of this disclosure are related to a UE that determines the number of uplink (UL) resources allocated to the selected logical channels (e.g., the LCHs that are eligible for PUSCH resources allocated by an initial UL grant) during logical channel prioritization (LCP) by considering MCS information associated with an LCH. The UE determines the MCS applied for a LCH based on the QoS requirements of an LCH (e.g., the UE determines whether the MCS for a LCH needs to be boosted relative to a reference MCS signaled for a PUSCH transmission). Additional aspects of this disclosure are related to uplink transmit power used for a PUSCH transmission includes more than one MCS (e.g., different MCSs used for different CBs and/or CBGs is determined according to the lowest MCS of multiple MCSs.

Aspects of the present disclosure are described in the context of a wireless communications system. In the wireless communications system, a UE and an NE (e.g., a base station, gNB, network entity, network node) may support wireless communication, including reception and/or transmission of wireless communication using time-frequency resources. For example, the UE and the NE may support communicating signals (e.g., carrying control information, data, or the like). It should be understood that various terms may be used interchangeably with “communicating,” such as “signaling,” “transmitting,” “receiving,” “outputting,” “forwarding,” “relaying,” “retrieving,” “obtaining,” and so forth.

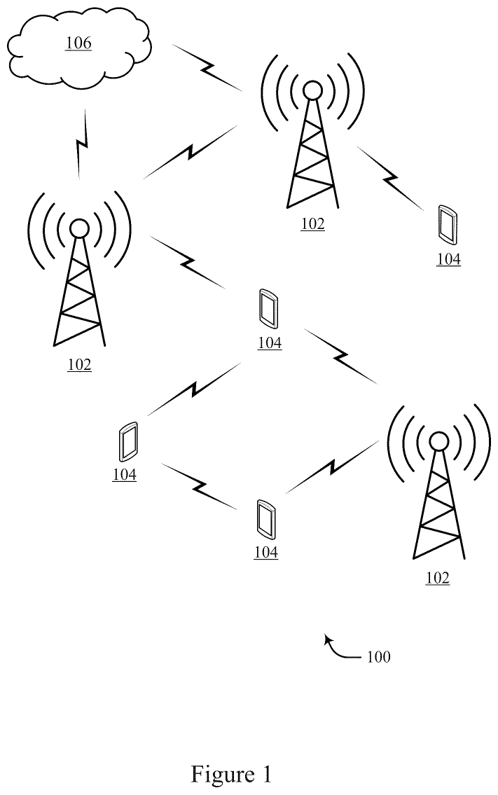

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, network infrastructure (or infrastructure), a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

Some wireless communications systems may support a transport block being comprised of CB and/or CBG(s) using a different MCS. A new LCH prioritization procedure is described that considers the QoS requirements of LCHs when generating a TB and determining an MCS to use for the corresponding CB and/or CBG the data is transmitted in. The techniques support CB(s) and/or CBG(s) of flexible length. In addition, a new power control mechanism supports multiple MCS in a PUSCH transmission, as described herein.

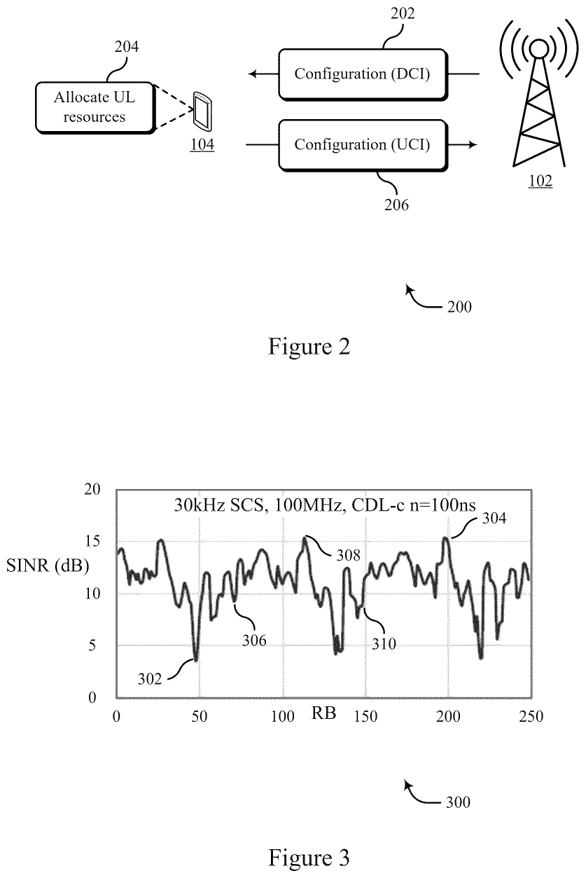

FIG. 2 illustrates an example 200 of wireless communication in accordance with aspects of the present disclosure. In the example 200, an NE 102 communicates (e.g., transmits, sends, signals) a configuration 202 (e.g., a configuration message) to a UE 104. The configuration 202 (e.g., DCI) includes an uplink resource assignment for a scheduled uplink transmission, and the DCI includes an indication of at least one MCS for the scheduled uplink transmission. The UE 104 receives the DCI that includes the uplink resource assignment for the scheduled uplink transmission, and the indication of the at least one MCS for the scheduled uplink transmission. The UE 104 allocates uplink resources for the scheduled uplink transmission from a set of LCHs (at 204), where a quantity of the uplink resources that are allocated for an LCH of the set of LCHs is based on one or more parameters associated with the LCH, and the one or more parameters include the at least one MCS for the scheduled uplink transmission. The UE 104 communicates (e.g., transmits, sends, signals), to the NE 102, configuration uplink control information (UCI) 206 that indicates a configuration of the UE 104. The NE 102 receives the configuration UCI that indicates the configuration of the UE 104.

FIG. 3 illustrates an example 300 of channel fluctuation in accordance with aspects of the present disclosure. The example 300 illustrates SINR in a transmit (Tx) wireless communication channel having 30 kilohertz (kHz) subcarrier spacing (SCS) across a 100 MHz bandwidth, using a clustered delay line (CDL) profile CDL-C, where n=100 nanoseconds. As illustrated, the Tx channel has channel fluctuation of greater than 10 dB, such as from approximately 4 dB at 302 to over 15 dB at 304. Using the techniques discussed herein, the UE 104 can select MCS for single TB transmission, such as an MCS for RB 75 through RB 120 because the channel fluctuation between RB 75 and RB 120 is approximately 6 dB (e.g., 9 dB at 306 and 15 dB at 308) and a different MCS for RB 120 through RB 150 because the channel fluctuation between RB 120 and RB 150 is approximately 11 dB (e.g., 15 dB at 308 and 4 db at 310).

With reference to frequency resource assignment (DL/UL), according to 3rd Generation Partnership Project (3GPP) technical specification (TS) 38.212, both UL and downlink (DL) resource assignments support only 1 single MCS assignment applicable to all assigned resource blocks. DCI Format 0_0 refers to an MCS of 5 bits. DCI Format 0_1 refers to, for TB 1, an MCS of 5 bits as defined in Clause 6.1.4.1 of 3GPP TS 38.214, and for TB 2 (only present if maxRank or maxMIMO-Layers is larger than 4), an MCS of 5 bits as defined in Clause 6.1.4.1 of 3GPP TS 38.214.

DCI Format 0_2 refers to an MCS of 5 bits as defined in Clause 6.1.4.1 of 3GPP TS 38.214. DCI Format 0_3 is used for the scheduling of one PUSCH in one cell, or multiple PUSCHs in multiple cells with one PUSCH per cell. The modulation and coding scheme is a number of bits determined by the following: block number 1, block number 2, . . . , block number N_{cell}^{UL}. Each block corresponds to the modulation and coding scheme for a cell, and the blocks are placed according to an ascending order of a serving cell index, with block number 1 corresponding to the modulation and coding scheme for the cell with the smallest serving cell index. Each block is 5 bits as defined in Clause 6.1.4.1 of 3GPP TS 38.214.

DCI Format 1_0 refers to an MCS of 5 bits. DCI Format 1_1, for TB 1, refers to an MCS of 5 bits as defined in Clause 5.1.3.1 of 3GPP TS 38.214, and for TB 2 (only present if maxNrofCodeWordsScheduledByDCI equals 2), refers to an MCS of 5 bits as defined in Clause 5.1.3.1 of 3GPP TS 38.214. DCI Format 1_2 refers to an MCS of 5 bits as defined in Clause 5.1.3.1 of 3GPP TS 38.214.

DCI Format 1_3 is used for the scheduling of one physical downlink shared channel (PDSCH) in one cell, or multiple PDSCHs in multiple cells with one PDSCH per cell. For TB 1: the modulation and coding scheme is a number of bits determined by the following: block number 1, block number 2, . . . , block number

$${N}_{cell}^{DL} .$$

Each block corresponds to the modulation and coding scheme for a cell, and the blocks are placed according to an ascending order of a serving cell index, with block number 1 corresponding to the modulation and coding scheme for the cell with the smallest serving cell index. Each block is 5 bits as defined in Clause 6.1.4.1 of 3GPP TS 38.214. For TB 2: the modulation and coding scheme is a number of bits determined by the following: block number 1, block number 2, . . . , block number

$${N}_{cell}^{DL , 3} .$$

DCI Format 4_0 refers to an MCS of 5 bits as defined in Clause 5.1.3 of 3GPP TS38.214. DCI Format 4_1 refers to an MCS of 5 bits as defined in Clause 5.1.3 of 3GPP TS38.214. DCI Format 4_2 refers to, for TB 1, an MCS of 5 bits as defined in Clause 5.1.3.1 of 3GPP TS 38.214, and for TB 2 (only present if maxNrofCodeWordsScheduledByDCI equals 2), an MCS of 5 bits as defined in Clause 5.1.3.1 of 3GPP TS 38.214.

While DCI formats 0_3/1_3 are capable of signaling a plurality of MCS fields, each such MCS field is applicable to a whole cell, and therefore to a single TB (i.e., the same MCS is applied to a TB).

Aspects of the present disclosure include techniques that support a transport block being comprised of CB and/or CBG(s) using a different MCS. A new LCH prioritization procedure is described that considers the QoS requirements of LCHs when generating a TB and determining an MCS to use for the corresponding CB and/or CBG the data is transmitted in. The techniques support CB(s) and/or CBG(s) of flexible length. In addition, a new power control mechanism supports multiple MCS in a PUSCH transmission, as described herein. This disclosure provides aspects that include TB processing and decomposition of a TB into CBs with characteristics that include a number of CBs per CBG is flexible; a number of bits per CB is also flexible, otherwise padding can be included or data from different LCHs are multiplexed in one CB; and a MCS (code rate) per CB and/or CBG is flexible (depending on the QoS requirements of the data). It should be noted that a lower MCS corresponds to more TF resources for the same number of information bits. A new LCP procedure is described for a scenario where different MCS is applied for different LCHs. In an implementation, an MCS for an LCH is determined based on network configuration, and boost indication is configured (e.g., different (lower) MCS compared to reference MCS). This disclosure also provides for mapping of MAC CE(s) within a TB (i.e., an MCS used for MAC CE(s)), and power control behavior for PUSCH transmission with multiple MCSs.

In some techniques, the resource signaling up to 5G NR supports only a single MCS signaling per transport block for a downlink resource assignment or an uplink resource grant. This means that the link adaptation cannot exploit frequency ranges with better SINR by a reduced FEC overhead, nor can it assign a more robust FEC to data mapped on frequency ranges with a poor MCS. Furthermore, as only a single common MCS is applied to all the data multiplexed in a TB, data of LCHs which may have different QoS requirements will be transmitted with the same MCS, which is inefficient from resource efficiency perspective. Typically, the MCS for a TB is selected and/or configured by the network to accommodate the highest demanding QoS of the data in a TB. However, such approach cannot exploit transmission of data parts in a TB with a reduced FEC overhead or higher MCS in general.

In some techniques, the logical channel prioritization and TB generation procedure would be performed regardless of the QoS requirements of a LCH (e.g., only the logical channel priority and the configured physical resource block (PRB) for LCHs determines the number of resources and/or bits allocated to a LCH during LCP. A single TB with a common MCS is used regardless of the different types of data multiplexed in the TB. Therefore, the corresponding PUSCH transmission would be inefficient from a resource usage and spectral efficiency perspective. The techniques described herein provide for a transport block of CB and/or CBG(s) using a different MCS, and a prioritization procedure that considers the QoS requirements of LCHs when generating a TB and determining an MCS to use for the corresponding CB and/or CBG the data is transmitted in. The techniques support CB(s) and/or CBG(s) of flexible length.

In one or more implementations, a transport block or MAC PDU includes data of one or more LCHs, where the data of different LCHs may have a different code rate and/or modulation order. The size of the CBs and/or CBGs of a MAC PDU or TB may differ (e.g., the CBs and/or CBGs of a TB may have different sizes). The MCS (code rate) per CB or CBG is flexible, where the MCS of a CB or CBG is selected depending on the QoS requirements of the data.

In one or more implementations, a UE determines the number of UL resources allocated to the selected logical channels (e.g., the LCHs that are eligible for PUSCH resources allocated by an initial UL grant) during LCP by considering MCS information associated with an LCH. The UE determines the MCS applied for a LCH based on the QoS requirements of an LCH (e.g., the UE determines whether the MCS for a LCH needs to be boosted relative to a reference MCS signaled for a PUSCH transmission). In one or more implementations, the uplink transmit power used for a PUSCH transmission including more than one MCS (e.g., different MCSs used for different CBs and/or CBGs) is determined according to the lowest MCS of the multiple MCSs.

In aspects of the described techniques, a transport block or MAC PDU includes data of one or more LCHs, where the data of different LCHs may have a different code rate and/or modulation order. According to some systems (5G NR), one MCS is applied to a MAC PDU and/or TB. This implies that the data multiplexed into a TB or MAC PDU is treated with the same QoS, even though data of different LCHs may have different QoS requirements. The MCS is assigned by the network in the DCI/UL grant. Given that a base station (e.g., gNB) may not be aware of the most up-to date buffer status in a UE, the MCS selection chosen by the network may not accurately address the QoS requirements of the LCHs being multiplexed onto the allocated UL resources (e.g., a base station (gNB) may not be able to precisely predict the outcome of the LCP procedure and hence is not aware of the data multiplexed in a MAC PDU or TB).

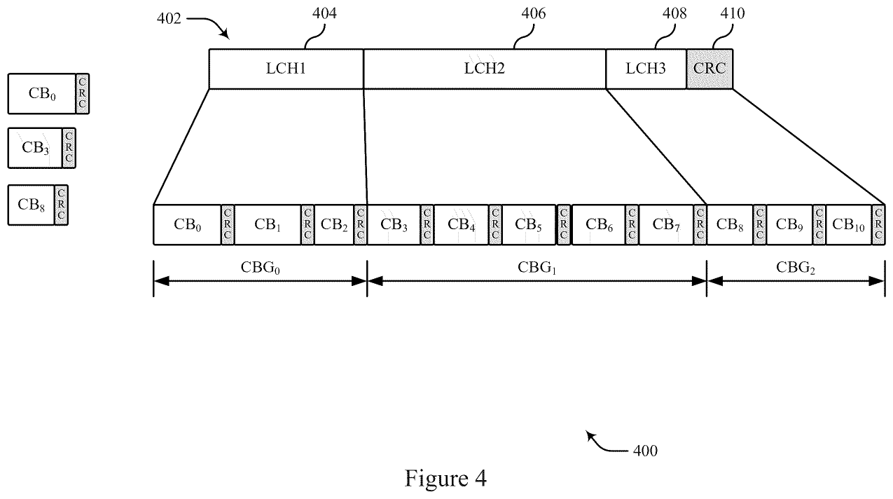

FIG. 4 illustrates an example 400 of a TB in accordance with aspects of the present disclosure. In this example 400, a TB 402 includes data of three different LCHs, such as LCH1 404, LCH2 406, and LCH3 408. In implementations, a UE segments a transport block or MAC PDU into one more segments or parts. Each of the segments are input to the channel encoder (e.g., low-density parity check (LDCP) code, turbo code, or polar code). The encoded segments are also referred to as CBs. In an implementation, one CB contains only data of one LCH. A cyclic redundancy check (CRC) 410 is attached to each of the CBs in an implementation. According to an implementation, the size of the CBs for a MAC PDU or TB may differ (e.g., the code blocks of a TB may have different sizes). Several CBs may form a CBG, which may contain only CBs from one LCH, such as shown in the example 400 along with aspects of TB encoding and segmentation.

As shown in this example 400, the TB contains the data of the three different LCHs. The LCH1 has the highest LCH priority and, in this example, has the most stringent QoS requirements (e.g., in terms of reliability and latency). The LCH2 has the second highest LCH priority, and LCH3 has the lowest LCH priority, and also the most relaxed QoS requirements. Accordingly, the MCS for LCH1 is selected to be lower than the MCS used for data of LCH2 and LCH3. In an example, the code rate used for CBs carrying data of LCH1 is lower than the code rate used for the CBs containing data of LCH2 and LCH3. The CB₀ for LCH1 may be larger in size because it requires more redundancy, and LCH1 is the highest priority logical channel and has the most stringent QoS in terms of latency and redundancy (e.g., as compared to the CBs of LCH2 and LCH3). The TB processing and decomposition of a TB into CBs has characteristics that include a number of CBs per CBG is flexible; a number of bits per CB is also flexible, otherwise padding can be provided or data from different LCHs are multiplexed in one CB; and the MCS (code rate) per CB/CBG is flexible (depending on the QoS requirements of the data). It should be noted that a lower MCS corresponds to more TF resources for same number of information bits.

In one or more implementations, a UE determines the number of UL resources allocated to the selected LCHs, which are eligible for PUSCH resources allocated by an initial UL grant, during LCP by considering MCS information associated with a LCH. According to an implementation, the UE determines the MCS used for data of a LCH for a PUSCH transmission. In an example, the UE determines the MCS to be applied for a LCH based on the QoS requirements of an LCH. In an implementation, the UE determines whether the MCS for a LCH needs to be boosted relative to a reference MCS that is signaled for a PUSCH transmission. The term “MCS boosting” refers to a technique where a lower MCS (that may be more reliable) compared to a reference MCS is used for a specific data or LCH.

In an implementation, the network configures the UE with MCS information for a LCH. In an example, the network configures whether the MCS for data of a specific LCH needs to be boosted or whether a different (higher or lower) MCS compared to a reference MCS needs to be used for a LCH. In a specific implementation, RRC signaling is used to signal whether the MCS of an LCH can or should be adapted (e.g., a higher or lower MCS compared to a reference MCS). The UE determines, based on information and/or configurations provided by the network and a reference MCS (e.g., signaled within a DCI), the MCS to be used for an LCH, respectively for a CB and/or CBG of the corresponding PUSCH transmission. This is an improvement over the current specifications, where the LCP procedure is performed regardless of the QoS requirements of a LCH (e.g., only the logical channel priority and the configured prioritized bit rate (PBR) for LCHs influences the amount of resources and/or bits allocated to a LCH during LCP).

In one or more implementations, the MAC entity shall, when a new transmission is performed: allocate resources to the logical channels as follows: logical channels selected in clause 5.4.3.1.2 for the UL grant with Bj>0 are allocated resources in a decreasing priority order. If the PBR of a logical channel is set to infinity, the MAC entity shall allocate resources for all the data that is available for transmission on the logical channel before meeting the PBR of the lower priority logical channel(s); decrement Bj by the total size of MAC SDUs served to logical channel j above; if any resources remain, all the logical channels selected in clause 5.4.3.1.2 are served in a strict decreasing priority order (regardless of the value of Bj) until either the data for that logical channel or the UL grant is exhausted, whichever comes first. Logical channels configured with equal priority should be served equally. NOTE 1: The value of Bj can be negative. If the MAC entity is requested to simultaneously transmit multiple MAC PDUs, or if the MAC entity receives the multiple UL grants within one or more coinciding physical downlink control channel (PDCCH) occasions (i.e., on different Serving Cells), it is up to UE implementation in which order the grants are processed.

In an implementation, a UE calculates the size of the information bits (e.g., bits which are allocated during LCP) for an LCH based on the modulation scheme and the code rate applied for an LCH. The following two examples describe the determination of the number of resources allocated for a LCH during LCP (not considering MAC header).

In a first example, with reference to a modulation order being the same for all LCHs, and the code rate being adaptable:
LCH1 and LCH2 are subject to LCP
LCH1: Code rate=0,75 (reference as signaled in the DCI)*0,75 (boost factor configured)=9/16
Bj before LCP: 400bits
Buffer status before LCP: 200bits
LCH priority: 1 (highest priority)
LCH2: Coderate=0,75 (reference MCS as signaled in the DCI, no MCS boost configured)
Bⱼ before LCP: 1000bits
Buffer status before LCP: 8000bits
LCH priority: 4
UL grant information
Resource allocation: 2 RBs=2*12*14 RE(s) and Modulation order: 16 QAM
Number of coded bits transmitted on the 2 RBs is: 2*12*14*4 (Mod)=1344 coded bits 1st round of LCP:
LCH1 (400 info bits); LCH2 (474 info bits); there will be no 2^{nd} LCP round since there are no remaining UL resources (coded bits) after the 1^{st} round.
LCH1: 400bits*16/9=712 coded bits
1344−712=632 coded bits available for LCH 2
632*3/4=474 info bits of LCH 2
Result of LCP: TB contains 400bits of LCH1 and 474bits of LCH2

In a second example, with reference to a modulation order that is different within the TB, and the code rate is different within the TB:
Resource allocation: 2 RBs=2*12*14 RE(s)=336
LCH1: 2000bits Buffer status Coderate=0,75 (reference MCS)*075 (MCS boosting factor)=9/16; Modulation order: QPSK
Bⱼ of LCH1 before LCP: 40bits
LCH2: 8000bits Buffer status Coderate=0,75 (reference MCS); Modulation order: 16 QAM
Bⱼ of LCH2 before LCP: 1000bits
1st round of LCP: LCH1 (40bits) LCH2 (399bits): There are no remaining uplink resources after the 1^{st} round of LCP, therefore no 2^{nd} LCP round.
LCH1: 40bits/2*16/9=70 RE(s)
336−70=266 RE(s) bits available for LCH 2
LCH 2: 266*4*3/4=798 info bits available for LCH2
Result: TB contains 40bits of LCH1 and 798bits of LCH2

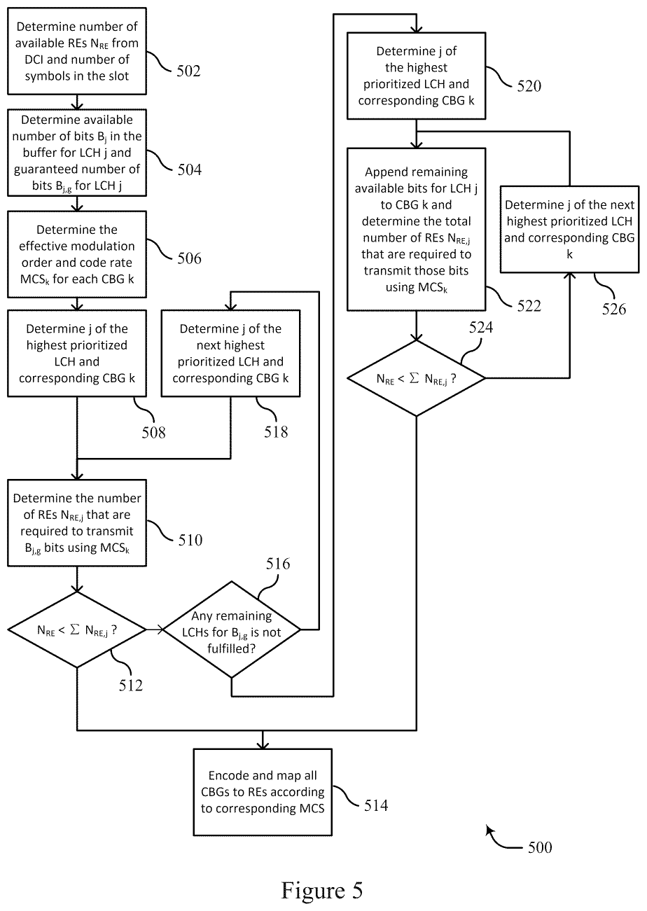

FIG. 5 illustrates a flowchart 500 of an example UE procedure in accordance with aspects of the present disclosure. The UE performs the procedure during LCP when using different MCS for data of different LCHs within a TB.

At 502, determine a number of available REs N_{RE} from DCI (e.g., a number of RBs (subcarriers) and a number of symbols in the slot)). At 504, determine an available number of bits Bⱼ in the buffer for LCH j and the guaranteed number of bits B_{j,g} for LCH j. At 506, determine the effective modulation order and code rate MCSk for each CBG k.

At 508, determine j of the highest prioritized LCH and corresponding CBG k. At 510, determine the number of RES N_{RE,j} that are required to transmit B_{j,g} bits using MCSₖ. At 512, a determination is made as to whether N_{RE}<ΣN_{RE,j}?

At 514, encode and map all CBGs to REs according to corresponding MCS. At 516, a determination is made as to whether any remaining LCHs for which B_{j,g} is not fulfilled. At 518, determine j of the next highest prioritized LCH and corresponding CBG k.

At 520, determine j of the highest prioritized LCH and corresponding CBG k. At 522, append the remaining available bits for LCH j to CBG k and determine the total number of REs N_{RE,j} that are required to transmit those bits using MCSₖ. At 524, a determination is made as to whether N_{RE}<ΣN_{RE,j}? At 526, determine j of the next highest prioritized LCH and corresponding CBG k.

In one or more implementations, MAC CEs contained in a TB are using the lowest MCS used for CB(s) and/or CBG(s) of the TB. According to an implementation, MAC CE(s) are mapped to the first CB(s) and/or CBG(s) of a TB which are using the lowest MCS (e.g., ensuring a reliable and robust transmission). In an alternative implementation, a predefined or preconfigured MCS is used for MAC CE(s), and in an example, RRC configures an MCS for the MAC CE(s). Different MAC CE(s) may be associated with a different MCS in accordance with their (relative) priority. In another example, the network configures (e.g., by RRC signaling), whether a MAC CE should be using a “boosted” MCS.

In one or more implementations, the uplink transmit power used for a PUSCH transmission being comprised of more than one MCS (e.g., different MCS is used for different CB(s) and/or CBG(s)) is determined according to the lowest MCS of the multiple MCS(s). According to current specifications, the PUSCH transmit power is determined according to the following formula:

$${P}_{PUSCH , b , f , c , k} ( i , j , {q}_{d} , l ) = min \{ \begin{matrix}{P}_{CMAX , f , c , k} ( i ) \\ {P}_{O \_ PUSCH , b , f , c} ( j ) + 10 {log}_{10} ( {2}^{μ} \cdot {M}_{RB , b , f , c}^{PUSCH} ( i ) ) + \\ {α}_{b , f , c} ( j ) \cdot {PL}_{b , f , c} ( {q}_{d} ) + {Δ}_{TF , b , f , c} ( i ) + {f}_{b , f , c} ( i , l )\end{matrix} \} [ dBm ]$$

One of the factors or elements of the power control formula includes ΔT_{F,b,f,c}(i), which is calculated based on the MCS used for the PUSCH transmission (e.g., power is adjusted according to the used MCS). In current specifications, only one MCS is used for a TB or PUSCH transmission. A new technique is implemented for scenarios where more than one MCS is used for a PUSCH transmission. In the implementation, a UE determines PUSCH transmit power for the case where multiple MCS(s) are used for a PUSCH transmission. In an example, one or more options may be selected for the determination of the PUSCH transmit power. An option 1, the lowest MCS of the set of MCS(s) being used for a PUSCH transmission is used for the determination of Δ_{TF,b,f,c}(i). An option 2, the highest MCS of the set of MCS(s) being used for a PUSCH transmission is used for the determination of Δ_{TF,b,f,c}(i). An option 3, an average MCS as determined based on a set of MCS(s) being used for a PUSCH transmission is used for the determination of Δ_{TF,b,f,c}(i). An option 4, the lowest MCS plus some delta MCS is used for the determination of Δ_{TF,b,f,c}(i). An option 5, the reference MCS as indicated in DCI is used for the determination of Δ_{TF,b,f,c}(i). In an option 6, a UE calculates the sum of the virtual power(s) per RB range (with MCS) and averages the total power (sum) over the OFDM carrier(s). It should be noted that the described UE techniques for PUSCH Tx power control is generally applicable for cases where more than one MCS is used for a PUSCH transmission, irrespective of whether an MCS is associated with a set of RB(s) or with a CB and/or CBG.

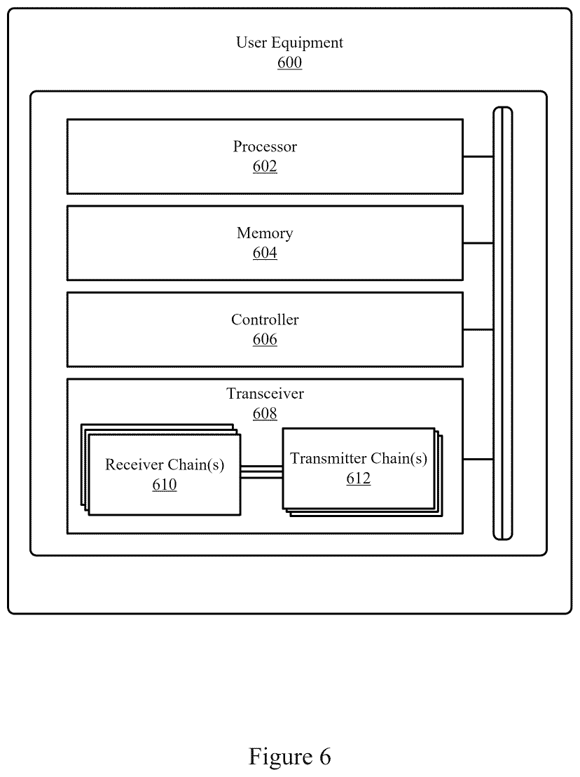

FIG. 6 illustrates an example of a UE 600 in accordance with aspects of the present disclosure. The UE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the UE 600 to perform various functions of the present disclosure.

The memory 604 may include volatile or non-volatile memory. The memory 604 may store computer-readable, computer-executable code including instructions when executed by the processor 602 cause the UE 600 to perform various functions described herein. The code may be stored in a non-transitory computer-readable medium such as the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to or operable to cause the UE 600 to perform one or more of the functions described herein (e.g., executing, by the processor 602, instructions stored in the memory 604). For example, the processor 602 may support wireless communication at the UE 600 in accordance with examples as disclosed herein. The UE 600 may be configured to or operable to support a means for receiving DCI that includes an uplink resource assignment for a scheduled uplink transmission, and the DCI includes an indication of at least one MCS for the scheduled uplink transmission; and allocating uplink resources for the scheduled uplink transmission from a set of LCHs, where a quantity of the uplink resources that are allocated for an LCH of the set of LCHs is based on one or more parameters associated with the LCH, and the one or more parameters include the at least one MCS for the scheduled uplink transmission.

Additionally, the UE 600 may be configured to or operable to support any one or combination of the DCI is an uplink DCI that allocates PUSCH resources for an initial HARQ transmission. The one or more parameters includes at least a priority and a prioritized bit rate configured for the LCH. The method further including applying one MCS to the LCH for the scheduled uplink transmission based on at least one of the indication of the at least one MCS received in the DCI, or QoS requirements of the LCH.

Additionally, or alternatively, the UE 600 may support at least one memory (e.g., the memory 604) and at least one processor (e.g., the processor 602) coupled with the at least one memory and configured to or operable to cause the UE to receive DCI that includes an uplink resource assignment for a scheduled uplink transmission, and the DCI includes an indication of at least one MCS for the scheduled uplink transmission; and allocate uplink resources for the scheduled uplink transmission from a set of LCHs, where a quantity of the uplink resources that are allocated for an LCH of the set of LCHs is based on one or more parameters associated with the LCH, and the one or more parameters include the at least one MCS for the scheduled uplink transmission.

Additionally, the UE 600 may be configured to or operable to support any one or combination of the DCI is an uplink DCI that allocates physical uplink shared channel (PUSCH) resources for an initial HARQ transmission. The one or more parameters includes at least a priority and a prioritized bit rate configured for the LCH. The at least one processor is operable to cause the UE to apply one MCS to the LCH for the scheduled uplink transmission based on at least one of the indication of the at least one MCS received in the DCI, or QoS requirements of the LCH. The at least one processor is operable to cause the UE to apply one MCS to the LCH for the scheduled uplink transmission based on a network configuration. The network configuration indicates to apply a lower or higher MCS relative to a reference MCS for the LCH. The at least one MCS is a reference MCS. The DCI includes the indication of the at least one MCS that is applied for highest priority data in a TB. MAC CEs in a TB utilize a lowest MCS for at least one of CBs or CBGs of the TB. The TB includes multiple CBGs, and a CBG of the multiple CBGs is associated with one MCS. At least one of a size of at least one CB of the CBs in the TB is a different size than another CB of the CBs; or a size of at least one CBG of the CBGs in the TB is a different size than another CBG of the CBGs. Coded bits of a CBG are received based on the MCS applied to a corresponding RB range. The processor is operable to cause the UE to determine a TBS from a set of partial TBSs, where a partial TBS is determined based on the at least one MCS applicable to a RB range and a number of scheduled RBs in the RB range. The TBS is determined based on a summation of the set of partial TBSs.

The controller 606 may manage input and output signals for the UE 600. The controller 606 may also manage peripherals not integrated into the UE 600. In some implementations, the controller 606 may utilize an operating system such as iOS®, ANDROID®, WINDOWS®, or other operating systems. In some implementations, the controller 606 may be implemented as part of the processor 602.

In some implementations, the UE 600 may include at least one transceiver 608. In some other implementations, the UE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas to receive a signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

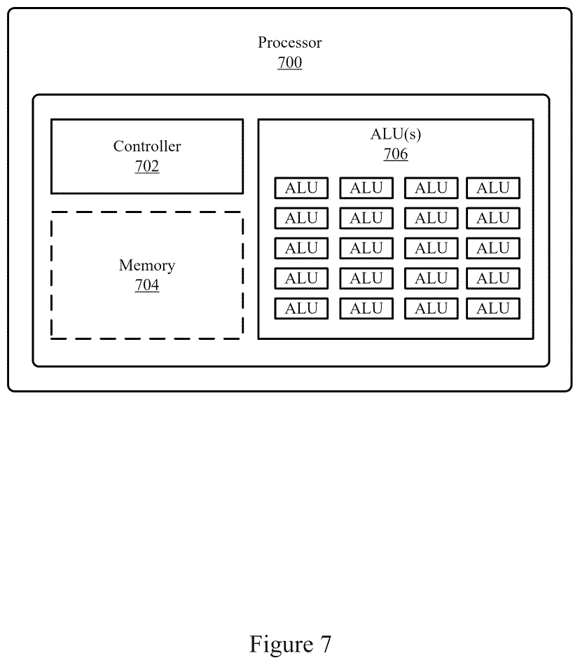

FIG. 7 illustrates an example of a processor 700 in accordance with aspects of the present disclosure. The processor 700 may be an example of a processor configured to perform various operations in accordance with examples as described herein. The processor 700 may include a controller 702 configured to perform various operations in accordance with examples as described herein. The processor 700 may optionally include at least one memory 704, which may be, for example, an L1/L2/L3 cache. Additionally, or alternatively, the processor 700 may optionally include one or more arithmetic-logic units (ALUs) 706. One or more of these components may be in electronic communication or otherwise coupled (e.g., operatively, communicatively, functionally, electronically, electrically) via one or more interfaces (e.g., buses).

The processor 700 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 700) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 702 may be configured to manage and coordinate various operations (e.g., signaling, receiving, obtaining, retrieving, transmitting, outputting, forwarding, storing, determining, identifying, accessing, writing, reading) of the processor 700 to cause the processor 700 to support various operations in accordance with examples as described herein. For example, the controller 702 may operate as a control unit of the processor 700, generating control signals that manage the operation of various components of the processor 700. These control signals include enabling or disabling functional units, selecting data paths, initiating memory access, and coordinating timing of operations.

The controller 702 may be configured to fetch (e.g., obtain, retrieve, receive) instructions from the memory 704 and determine subsequent instruction(s) to be executed to cause the processor 700 to support various operations in accordance with examples as described herein. The controller 702 may be configured to track memory addresses of instructions associated with the memory 704. The controller 702 may be configured to decode instructions to determine the operation to be performed and the operands involved. For example, the controller 702 may be configured to interpret the instruction and determine control signals to be output to other components of the processor 700 to cause the processor 700 to support various operations in accordance with examples as described herein. Additionally, or alternatively, the controller 702 may be configured to manage flow of data within the processor 700. The controller 702 may be configured to control transfer of data between registers, ALUs 706, and other functional units of the processor 700.

The memory 704 may include one or more caches (e.g., memory local to or included in the processor 700 or other memory, such as RAM, ROM, DRAM, SDRAM, SRAM, MRAM, flash memory, etc. In some implementations, the memory 704 may reside within or on a processor chipset (e.g., local to the processor 700). In some other implementations, the memory 704 may reside external to the processor chipset (e.g., remote to the processor 700).

The memory 704 may store computer-readable, computer-executable code including instructions that, when executed by the processor 700, cause the processor 700 to perform various functions described herein. The code may be stored in a non-transitory computer-readable medium such as system memory or another type of memory. The controller 702 and/or the processor 700 may be configured to execute computer-readable instructions stored in the memory 704 to cause the processor 700 to perform various functions. For example, the processor 700 and/or the controller 702 may be coupled with or to the memory 704, the processor 700, and the controller 702, and may be configured to perform various functions described herein. In some examples, the processor 700 may include multiple processors and the memory 704 may include multiple memories. One or more of the multiple processors may be coupled with one or more of the multiple memories, which may, individually or collectively, be configured to perform various functions herein.

The one or more ALUs 706 may be configured to support various operations in accordance with examples as described herein. In some implementations, the one or more ALUs 706 may reside within or on a processor chipset (e.g., the processor 700). In some other implementations, the one or more ALUs 706 may reside external to the processor chipset (e.g., the processor 700). One or more ALUs 706 may perform one or more computations such as addition, subtraction, multiplication, and division on data. For example, one or more ALUs 706 may receive input operands and an operation code, which determines an operation to be executed. One or more ALUs 706 may be configured with a variety of logical and arithmetic circuits, including adders, subtractors, shifters, and logic gates, to process and manipulate the data according to the operation.

Additionally, or alternatively, the one or more ALUs 706 may support logical operations such as AND, OR, exclusive-OR (XOR), not-OR (NOR), and not-AND (NAND), enabling the one or more ALUs 706 to handle conditional operations, comparisons, and bitwise operations.

The processor 700 may support wireless communication in accordance with examples as disclosed herein. The processor 700 may be configured to support at least one controller (e.g., the controller 702) coupled with at least one memory (e.g., the memory 704) and configured to or operable to cause the processor to receive DCI that includes an uplink resource assignment for a scheduled uplink transmission, and the DCI includes an indication of at least one MCS for the scheduled uplink transmission; and allocate uplink resources for the scheduled uplink transmission from a set of LCHs, where a quantity of the uplink resources that are allocated for an LCH of the set of LCHs is based on one or more parameters associated with the LCH, and the one or more parameters include the at least one MCS for the scheduled uplink transmission.

Additionally, the processor 700 may be configured to or operable to support any one or combination of the DCI is an uplink DCI that allocates PUSCH resources for an initial HARQ transmission. The one or more parameters includes at least a priority and a prioritized bit rate configured for the LCH. The at least one controller is operable to cause the processor to apply one MCS to the LCH for the scheduled uplink transmission based on at least one of the indication of the at least one MCS received in the DCI, or QoS requirements of the LCH. The at least one controller is operable to cause the processor to apply one MCS to the LCH for the scheduled uplink transmission based at least in part on a network configuration. The network configuration indicates to apply a lower or higher MCS relative to a reference MCS for the LCH. The at least one MCS is a reference MCS. The DCI includes the indication of the at least one MCS that is applied for highest priority data in a TB. MAC CEs in a TB utilize a lowest MCS for at least one of CBs or CBGs of the TB. The TB includes multiple CBGs, and a CBG of the multiple CBGs is associated with one MCS. At least one of a size of at least one CB of the CBs in the TB is a different size than another CB of the CBs; or a size of at least one CBG of the CBGs in the TB is a different size than another CBG of the CBGs. Coded bits of a CBG are received based on the MCS applied to a corresponding RB range. The controller is operable to cause the processor to determine a TBS from a set of partial TBSs, wherein a partial TBS is determined based on the at least one MCS applicable to a RB range and a number of scheduled RBs in the RB range. The TBS is determined based on a summation of the set of partial TBSs.

The processor 700 may support wireless communication in accordance with examples as disclosed herein. The processor 700 may be configured to support at least one controller (e.g., the controller 702) coupled with at least one memory (e.g., the memory 704) and configured to or operable to cause the processor to transmit DCI that includes an uplink resource assignment for a scheduled uplink transmission, and the DCI includes an indication of at least one MCS for the scheduled uplink transmission, wherein the DCI is usable to allocate uplink resources for the scheduled uplink transmission from a set of LCHs, where a quantity of the uplink resources that are allocated for an LCH of the set of LCHs is based on one or more parameters associated with the LCH, and the one or more parameters include the at least one MCS for the scheduled uplink transmission.

Additionally, the processor 700 may be configured to or operable to support any one or combination of the DCI is an uplink DCI that allocates PUSCH resources for an initial HARQ transmission. The one or more parameters includes at least a priority and a prioritized bit rate configured for the LCH. The network configuration indicates to apply a lower or higher MCS relative to a reference MCS for the LCH. The at least one MCS is a reference MCS. The DCI includes the indication of the at least one MCS that is applied for highest priority data in a TB.

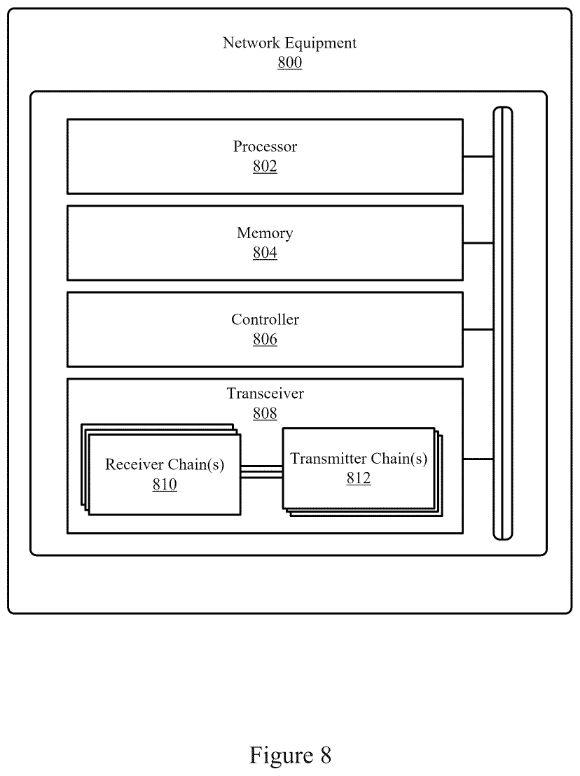

FIG. 8 illustrates an example of an NE 800 in accordance with aspects of the present disclosure. The NE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the NE 800 to perform various functions of the present disclosure.

The memory 804 may include volatile or non-volatile memory. The memory 804 may store computer-readable, computer-executable code including instructions when executed by the processor 802 cause the NE 800 to perform various functions described herein. The code may be stored in a non-transitory computer-readable medium such as the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the NE 800 to perform one or more of the functions described herein (e.g., executing, by the processor 802, instructions stored in the memory 804). For example, the processor 802 may support wireless communication at the NE 800 in accordance with examples as disclosed herein. The NE 800 may be configured to or operable to support a means for transmitting DCI that includes an uplink resource assignment for a scheduled uplink transmission, and the DCI includes an indication of at least one MCS for the scheduled uplink transmission, where the DCI is usable to allocate uplink resources for the scheduled uplink transmission from a set of LCHs, where a quantity of the uplink resources that are allocated for an LCH of the set of LCHs is based on one or more parameters associated with the LCH, and the one or more parameters include the at least one MCS for the scheduled uplink transmission.

Additionally, the NE 800 may be configured to or operable to support any one or combination of the DCI is an uplink DCI that allocates PUSCH resources for an initial HARQ transmission. The one or more parameters includes at least a priority and a prioritized bit rate configured for the LCH. The network configuration indicates to apply a lower or higher MCS relative to a reference MCS for the LCH. The at least one MCS is a reference MCS. The DCI includes the indication of the at least one MCS that is applied for highest priority data in a TB.

Additionally, or alternatively, the NE 800 may support at least one memory (e.g., the memory 804) and at least one processor (e.g., the processor 802) coupled with the at least one memory and configured to or operable to cause the NE to transmit DCI that includes an uplink resource assignment for a scheduled uplink transmission, and the DCI includes an indication of at least one MCS for the scheduled uplink transmission, wherein the DCI is usable to allocate uplink resources for the scheduled uplink transmission from a set of LCHs, where a quantity of the uplink resources that are allocated for an LCH of the set of LCHs is based on one or more parameters associated with the LCH, and the one or more parameters include the at least one MCS for the scheduled uplink transmission.

Additionally, the NE 800 may be configured to or operable to support any one or combination of the DCI is an uplink DCI that allocates PUSCH resources for an initial HARQ transmission. The one or more parameters includes at least a priority and a prioritized bit rate configured for the LCH. The network configuration indicates to apply a lower or higher MCS relative to a reference MCS for the LCH. The at least one MCS is a reference MCS. The DCI includes the indication of the at least one MCS that is applied for highest priority data in a TB.

The controller 806 may manage input and output signals for the NE 800. The controller 806 may also manage peripherals not integrated into the NE 800. In some implementations, the controller 806 may utilize an operating system such as iOS®, ANDROID®, WINDOWS®, or other operating systems. In some implementations, the controller 806 may be implemented as part of the processor 802.

In some implementations, the NE 800 may include at least one transceiver 808. In some other implementations, the NE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas to receive a signal over the air or wireless medium. The receiver chain 810 may include at least one amplifier (e.g., a low-noise amplifier (LNA)) configured to amplify the received signal. The receiver chain 810 may include at least one demodulator configured to demodulate the receive signal and obtain the transmitted data by reversing the modulation technique applied during transmission of the signal. The receiver chain 810 may include at least one decoder for decoding the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

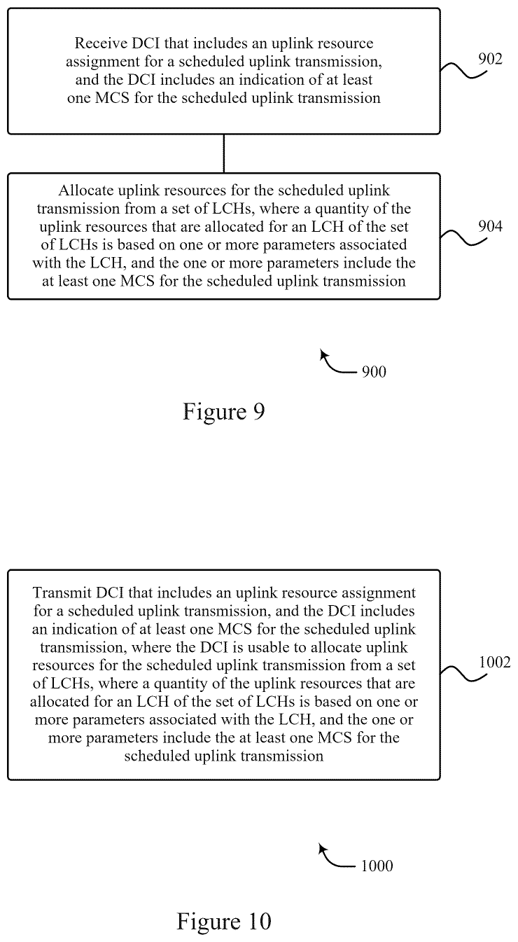

FIG. 9 illustrates a flowchart of a method 900 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 902, the method may include receiving DCI that includes an uplink resource assignment for a scheduled uplink transmission, and the DCI includes an indication of at least one MCS for the scheduled uplink transmission. The operations of 902 may be performed in accordance with examples as described herein. In some implementations, aspects of the operations of 902 may be performed by a UE as described with reference to FIG. 6.

At 904, the method may include allocating uplink resources for the scheduled uplink transmission from a set of LCHs, where a quantity of the uplink resources that are allocated for an LCH of the set of LCHs is based on one or more parameters associated with the LCH, and the one or more parameters include the at least one MCS for the scheduled uplink transmission. The operations of 904 may be performed in accordance with examples as described herein. In some implementations, aspects of the operations of 904 may be performed by a UE as described with reference to FIG. 6.

FIG. 10 illustrates a flowchart of a method 1000 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1002, the method may include transmitting DCI that includes an uplink resource assignment for a scheduled uplink transmission, and the DCI includes an indication of at least one MCS for the scheduled uplink transmission, where the DCI is usable to allocate uplink resources for the scheduled uplink transmission from a set of LCHs, where a quantity of the uplink resources that are allocated for an LCH of the set of LCHs is based on one or more parameters associated with the LCH, and the one or more parameters include the at least one MCS for the scheduled uplink transmission. The operations of 1002 may be performed in accordance with examples as described herein. In some implementations, aspects of the operations of 1002 may be performed by an NE as described with reference to FIG. 8.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
receive downlink control information (DCI) that includes an uplink resource assignment for a scheduled uplink transmission, and the DCI includes an indication of at least one modulation and coding scheme (MCS) for the scheduled uplink transmission; and
allocate uplink resources for the scheduled uplink transmission from a set of logical channels (LCHs), wherein a quantity of the uplink resources that are allocated for an LCH of the set of LCHs is based at least in part on one or more parameters associated with the LCH, and the one or more parameters include the at least one MCS for the scheduled uplink transmission.

2. The UE of claim 1, wherein the DCI is an uplink DCI that allocates physical uplink shared channel (PUSCH) resources for an initial hybrid automatic repeat request (HARQ) transmission.

3. The UE of claim 1, wherein the one or more parameters includes at least a priority and a prioritized bit rate configured for the LCH.

4. The UE of claim 1, wherein the at least one processor is operable to cause the UE to apply one MCS to the LCH for the scheduled uplink transmission based on at least one of the indication of the at least one MCS received in the DCI, or quality-of-service (QoS) requirements of the LCH.

5. The UE of claim 1, wherein the at least one processor is operable to cause the UE to apply one MCS to the LCH for the scheduled uplink transmission based at least in part on a network configuration.

6. The UE of claim 5, wherein the network configuration indicates to apply a lower or higher MCS relative to a reference MCS for the LCH.

7. The UE of claim 1, wherein the at least one MCS is a reference MCS.

8. The UE of claim 1, wherein the DCI includes the indication of the at least one MCS that is applied for highest priority data in a transport block (TB).

9. The UE of claim 1, wherein medium access control-control elements (MAC CEs) in a transport block (TB) utilize a lowest MCS for at least one of code blocks (CBs) or code block groups (CBGs) of the TB.

10. The UE of claim 9, wherein the TB includes multiple CBGs, and a CBG of the multiple CBGs is associated with one MCS.

11. The UE of claim 9, wherein at least one of:
a size of at least one CB of the CBs in the TB is a different size than another CB of the CBs; or
a size of at least one CBG of the CBGs in the TB is a different size than another CBG of the CBGs.

12. The UE of claim 1, wherein coded bits of a code block group (CBG) are received based on the MCS applied to a corresponding resource block (RB) range.

13. The UE of claim 1, wherein the processor is operable to cause the UE to determine a transport block size (TBS) from a set of partial TBSs, wherein a partial TBS is determined based on the at least one MCS applicable to a resource block (RB) range and a number of scheduled RBs in the RB range.

14. The UE of claim 13, wherein the TBS is determined based on a summation of the set of partial TBSs.

15. A method performed by a user equipment (UE), the method comprising:
receiving downlink control information (DCI) that includes an uplink resource assignment for a scheduled uplink transmission, and the DCI includes an indication of at least one modulation and coding scheme (MCS) for the scheduled uplink transmission; and
allocating uplink resources for the scheduled uplink transmission from a set of logical channels (LCHs), wherein a quantity of the uplink resources that are allocated for an LCH of the set of LCHs is based at least in part on one or more parameters associated with the LCH, and the one or more parameters include the at least one MCS for the scheduled uplink transmission.

16. The method of claim 15, wherein the DCI is an uplink DCI that allocates physical uplink shared channel (PUSCH) resources for an initial hybrid automatic repeat request (HARQ) transmission.

17. The method of claim 15, wherein the one or more parameters includes at least a priority and a prioritized bit rate configured for the LCH.

18. The method of claim 15, further comprising:
applying one MCS to the LCH for the scheduled uplink transmission based on at least one of the indication of the at least one MCS received in the DCI, or quality-of-service (QoS) requirements of the LCH.

19. A network equipment (NE) for wireless communication, comprising:
at least one memory; and
at least one processor coupled with the at least one memory and operable to cause the NE to:
transmit downlink control information (DCI) that includes an uplink resource assignment for a scheduled uplink transmission, and the DCI includes an indication of at least one modulation and coding scheme (MCS) for the scheduled uplink transmission, wherein the DCI is usable to allocate uplink resources for the scheduled uplink transmission from a set of logical channels (LCHs), wherein a quantity of the uplink resources that are allocated for an LCH of the set of LCHs is based at least in part on one or more parameters associated with the LCH, and the one or more parameters include the at least one MCS for the scheduled uplink transmission.

20. A method performed by a network equipment (NE), the method comprising:
transmitting downlink control information (DCI) that includes an uplink resource assignment for a scheduled uplink transmission, and the DCI includes an indication of at least one modulation and coding scheme (MCS) for the scheduled uplink transmission, wherein the DCI is usable to allocate uplink resources for the scheduled uplink transmission from a set of logical channels (LCHs), wherein a quantity of the uplink resources that are allocated for an LCH of the set of LCHs is based at least in part on one or more parameters associated with the LCH, and the one or more parameters include the at least one MCS for the scheduled uplink transmission.
